(19) United States
(12) Patent Application Publication
(10) Pub. No.: US 2020/0018976 A1
(43) Pub. Date: Jan. 16, 2020

(54) PASSENGER HEADS-UP DISPLAYS FOR VEHICLES

(71) Applicant: Ford Global Technologies, LLC, Dearborn, MI (US)

(72) Inventors: John Robert Van Wiemeersch, Novi, MI (US); Erick Michael Lavoie, Dearborn, MI (US); Thomas Joseph Hermann, Troy, MI (US); Alyssa Chatten, Royal Oak, MI (US)

(21) Appl. No.: 16/031,977

(22) Filed: Jul. 10, 2018

(51) Int. Cl. G02B 27/01; B60K 35/00; G01C 21/36; G06F 17/28; G10L 15/00; G10L 15/18; G06F 3/01; G06F 3/16

(52) U.S. Cl. CPC G02B 27/0179; B60K 35/00; G01C 21/3679; G06F 17/289; G10L 15/005; G02B 2027/0181; G06F 3/017; G06F 3/16; B60K 2350/903; B60K 2350/2052; G10L 15/18

(57) ABSTRACT

Method and apparatus are disclosed for passenger heads-up displays for vehicles. An example vehicle includes a passenger seat, a passenger heads-up display (HUD) to present a virtual interface in front of the passenger seat, and a controller. The controller is to identify a mode selection for the passenger HUD and determine, based on the mode selection, the virtual interface and an apparent distance of the virtual interface for a passenger. The controller also is to present, via the passenger HUD, the virtual interface at the apparent distance for the passenger.

### TECHNICAL FIELD

The present disclosure generally relates to heads-up displays and, more specifically, to passenger heads-up displays for vehicles.

### BACKGROUND

Recently, vehicles have incorporated heads-up displays that project images onto transparent surfaces, such as windshields, to create transparent interfaces within fields-of-view of drivers. For example, a heads-up display presents information, such as a current vehicle speed, the speed limit, directions, etc., to enable the driver to identify such information without looking away from the road on which the vehicle is travelling.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for passenger heads-up displays for vehicles. An example disclosed vehicle includes a passenger seat, a passenger heads-up display (HUD) to present a virtual interface in front of the passenger seat, and a controller. The controller is to identify a mode selection for the passenger HUD and determine, based on the mode selection, the virtual interface and an apparent distance of the virtual interface for a passenger. The controller also is to present, via the passenger HUD, the virtual interface at the apparent distance for the passenger.

An example disclosed method includes identifying a mode selection from a passenger of a vehicle for a passenger heads-up display (HUD). The passenger HUD is configured to present a virtual interface in front of a passenger seat. The example disclosed method also includes determining, via a processor, the virtual interface and an apparent distance of the virtual interface for the passenger based on the mode selection. The example disclosed method also includes presenting, via the passenger HUD, the virtual interface at the apparent distance for the passenger.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle including an example passenger heads-up display in accordance with the teachings herein.

FIG. 2 depicts an example heads-up display.

FIG. 3A depicts the passenger heads-up display of FIG. 1 presenting example information in accordance with the teachings herein.

FIG. 3B depicts an example passenger heads-up display of the vehicle of FIG. 1 presenting other example information in accordance with the teachings herein.

FIG. 4 depicts the passenger heads-up display of FIG. 1 presenting other example information in accordance with the teachings herein.

FIG. 5 is a block diagram of electronic components of the vehicle of FIG. 1.

FIG. 6 is a flowchart for presenting an interface via a passenger heads-up display in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Recently, vehicles have incorporated heads-up displays that project images onto transparent surfaces, such as windshields, to create transparent interfaces within fields-of-view of drivers. For example, a heads-up display presents information, such as a current vehicle speed, the speed limit, directions, etc., to enable the driver to identify such information without looking away from the road on which the vehicle is travelling. Typically, a front passenger is unable to view the information due to a narrow field-of-view optimized for the driver positioned in a driver's seat.

Also recently, vehicles have become more-and-more passenger-centric. For instance, in a taxi and/or ride-sharing vehicle (e.g., an autonomous vehicle), the passenger experience is important to the operator of the vehicle. For instance, a passenger potentially may experience a variety of challenges during their ride regarding their interaction with a driver and/or other passenger(s).

Example methods and apparatus disclosed herein utilize a heads-up display to improve the experience of a passenger within a vehicle. Examples disclosed herein include a system of a vehicle (e.g., taxi vehicle) that includes a passenger heads-up display (P-HUD). The system adjusts an apparent distance of information presented via the P-HUD based upon the type of information to be presented. For example, the system (1) presents information related to language or cultural differences at a closer apparent distance via the P-HUD, (2) presents information related to tourism or directions at a farther apparent distance via the P-HUD, (3) presents information related to mobile device functions at a closer apparent distance via the P-HUD, and/or (4) presents information related to nearby products and services on sale at a farther apparent distance via the P-HUD.

As used herein, a “heads-up display” and a “HUD” refer to a system that projects an image onto a transparent surface to create a transparent interface (also referred to as a virtual distance) within a field-of-view of a user. For example, a heads-up display of a vehicle projects an image onto a transparent surface of a vehicle through which an occupant looks (e.g., a windshield) to create a transparent interface within a typical field-of-view of the occupant (e.g., through the windshield) seated directly in front of the heads-up display. As used herein, an “apparent distance” and a “virtual distance” refers to a distance at which a transparent interface appears from a perspective of a user in front of the transparent surface. For example, a heads-up display may project an image onto a transparent surface to create a transparent interface such that, from the perspective of a user in front of the transparent surface, the transparent interface appears farther than the transparent surface.

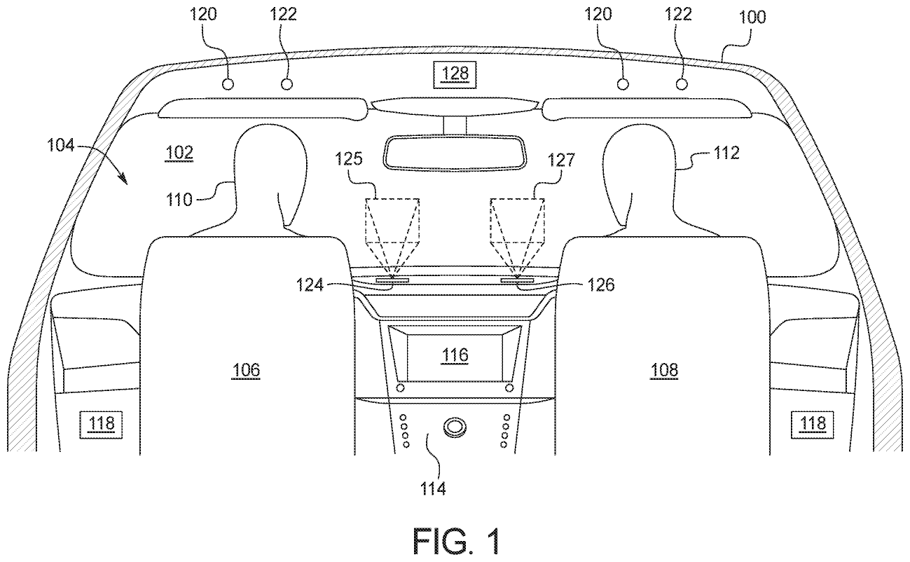

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

As illustrated in FIG. 1, the vehicle 100 (e.g., a taxi vehicle, a ride-sharing vehicle) includes a windshield 102 and a cabin 104 at least partially defined by the windshield 102. For example, the windshield 102 (also referred to as a front windshield) is formed of laminated or safety glass to prevent the windshield 102 from shattering into sharp pieces during a collision event. The cabin 104 includes a driver's seat 106 and a passenger seat 108. In the illustrated example, an operator 110 (e.g., a driver such as a taxi driver or a ride-sharing driver) is seated in the driver's seat 106, and a passenger 112 is seated in the passenger seat 108. The windshield 102 enables the operator 110 and the passenger 112 seated within the cabin 104 to observe a surrounding area in front and/or to the side of the vehicle 100.

The vehicle 100 of the illustrated example also includes a center console 114. For example, the center console 114 provides an interface between the vehicle 100 and the operator 110 and/or the passenger 112. In the illustrated example, the center console 114 includes digital and/or analog interfaces (e.g., input devices and output devices) to receive input from and display information for the user(s). The input devices include, for example, a control knob, an instrument panel, a touch screen, an audio input device a button, a touchpad, etc. The output devices may include instrument cluster output(s), such as dials, lighting devices, etc. In the illustrated example, the output device(s) of the center console 114 include a center console display 116 (e.g., a liquid crystal display (LCD), an organic light emitting diode (OLED) display, a flat panel display, a solid state display, etc.). For example, the center console display 116 is configured to present interface(s) to the operator 110 and/or the passenger 112 of the vehicle 100.

In the illustrated example, the vehicle 100 includes one or more speakers 118 and/or one or more microphones 120. The speakers 118 are configured to emit audio signals within the cabin 104. For example, the speakers 118 emit audio (e.g., instructions, directions, entertainment, and/or other information) to the operator 110 and/or the passenger 112. Further, the microphones 120 collect audio signals from within the cabin 104. For example, one or more of the microphones 120 are configured to collect speech signals of the operator 110 and/or one or more of the microphones 120 are configured to collect speech signals of the passenger 112.

The vehicle 100 of the illustrated example also includes one or more cameras 122 to capture image(s) and/or video within the cabin 104 of the vehicle 100. For example, one or more of the cameras 122 are positioned and oriented to capture image(s) and/or video of the passenger 112 seated within the passenger seat 108. In some examples, the image(s) and/or video of the passenger 112 are captured to facilitate detection of a presence, a position, and/or hand gesture(s) of the passenger 112.

As illustrated in FIG. 1, the vehicle 100 includes a driver heads-up display 124 (also referred to as a driver HUD, a D-HUD, an operator heads-up display, an operator HUD, and an O-HUD) and a passenger heads-up display 126 (also referred to as a passenger HUD, a P-HUD). The driver HUD 124 is configured to present a virtual interface 125 (sometimes referred to as a virtual operator interface or a virtual driver interface) in front of the driver's seat 106 for the operator 110, and the passenger HUD 126 is configured to present a virtual interface 127 (sometimes referred to as a virtual passenger interface) in front of the passenger seat 108 for the passenger 112. In the illustrated example, the driver HUD 124 projects the virtual interface 125 in front of the driver's seat 106 such that the virtual interface 125 is viewable by the operator 110 seated at the driver's seat 106 and not viewable by the passenger 112 seated at the passenger seat 108. Further, the passenger HUD 126 projects the virtual interface 127 in front of the passenger seat 108 such that the virtual interface 127 is viewable by the passenger 112 seated at the passenger seat 108 and not viewable by the operator 110 seated at the driver's seat 106.

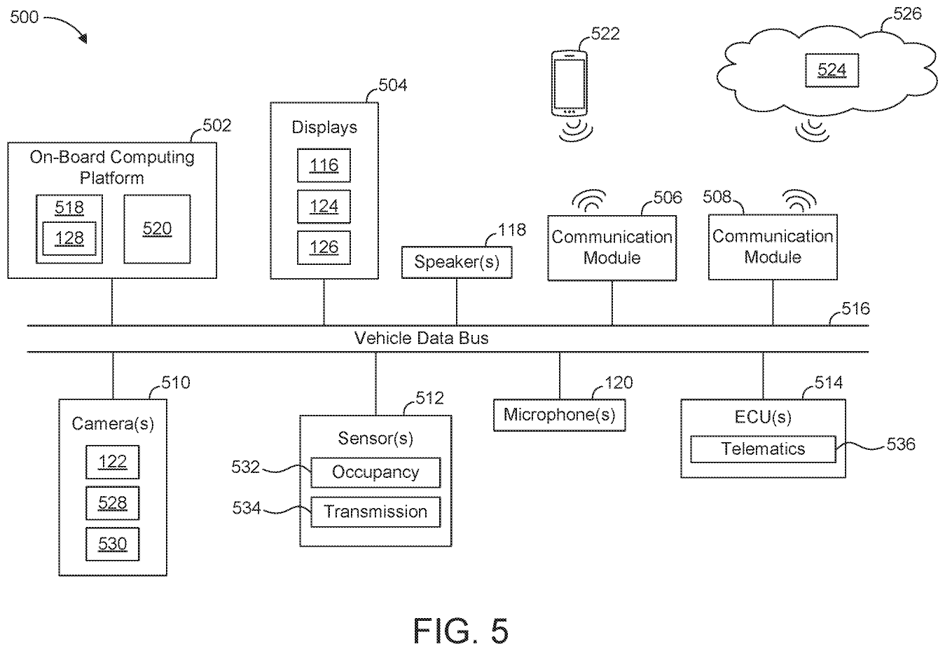

The vehicle 100 also includes a HUD controller 128 that is configured to control operation of the passenger HUD 126 and/or the driver HUD 124. For example, the HUD controller 128 is configured to identify a mode selection (e.g., a point-of-interest mode, a language mode, a mobile device mode, etc.) for the passenger 112. In some examples, the HUD controller 128 receives the mode selection from the passenger 112 via (1) a mobile device (e.g., a mobile device 522 of FIG. 5) of the passenger 112 and/or other passenger(s) (e.g., passenger(s) in a second row or third row of the vehicle 100), (2) input device(s) of the center console 114, (3) the microphones 120, (4) gesture-detection of the passenger 112 based upon image(s) captured by the cameras 122, and/or (4) other input device(s) of the vehicle 100. In other examples, the HUD controller 128 receives the mode selection from the operator 110 on behalf of the passenger 112 via (1) a mobile device (e.g., the mobile device 522) of the operator 110, (2) input device(s) of the center console 114, (3) the microphones 120, (4) gesture-detection of the operator 110 based upon image(s) captured by the cameras 122, and/or (4) other input device(s) of the vehicle 100. Additionally, or alternatively, the HUD controller 128 enables the operator 110 to limit content of the passenger HUD 126 as a function of status of the journey. For example, if the passenger 112 is approaching the end of the journey, the HUD controller 128 is configured to restrict some content to prioritize reminder messages to gather belongings and/or prepare for departure, payment instructions, etc.

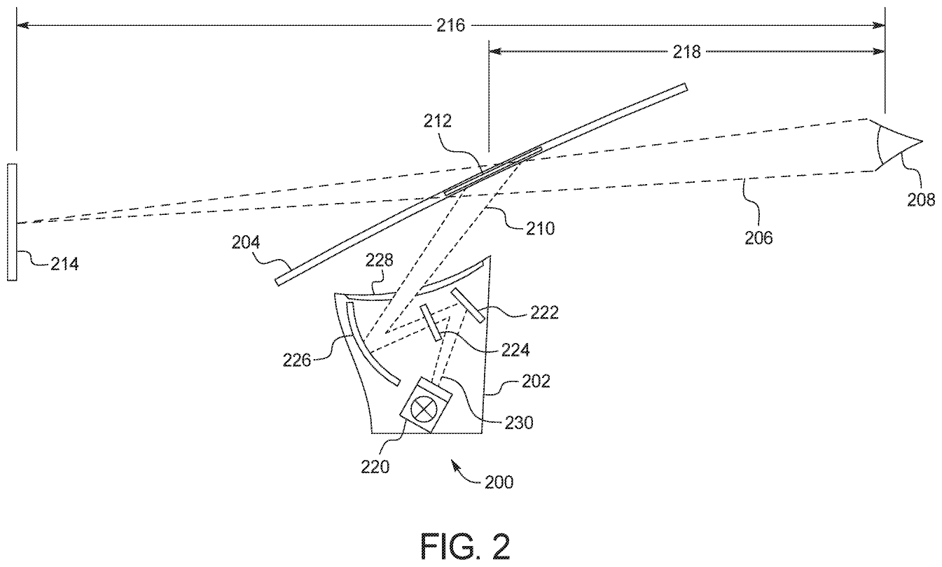

Based on the mode selected by or for the passenger 112, the HUD controller 128 determines a virtual interface to be presented to the passenger 112 by the passenger HUD 126. Further, the HUD controller 128 determines an apparent distance (e.g., an apparent distance 216 of FIG. 2) for the virtual interface based on the mode selected by the passenger 112. Additionally or alternatively, the HUD controller 128 determines the virtual interface and/or the apparent distance based on a content priority, a vehicle state, a journey status, a passenger usage, and/or a driver usage. The apparent distance is a distance at which the virtual interface presented by the passenger HUD 126 appears from a perspective of the passenger 112 from the passenger seat 108. For example, the apparent distance for some HUD modes (e.g., a language mode, a mobile device mode) is shorter than the apparent distance corresponding to one other HUD modes (e.g., a point-of-interest mode). That is, the virtual interface for some HUD modes (e.g., a language mode, a mobile device mode) is closer to the passenger 112 than other HUD modes (e.g., a point-of-interest mode). Subsequently, upon determining the virtual interface and the corresponding apparent distance, the HUD controller 128 instructs the passenger HUD 126 to present the virtual interface at the apparent distance for the passenger 112.

FIG. 2 depicts an example heads-up display (HUD) 200 that is representative of each of the driver HUD 124 and the passenger HUD 126 of FIG. 1. In the illustrated example, the HUD 200 includes a projector 202 and a transparent surface 204 within a field-of-view 206 of a user 208 (e.g. the operator 110, the passenger 112) in front of the transparent surface 204. In some examples, the transparent surface 204 is formed by a surface of the windshield 102 through which the user 208 looks during operation of the vehicle 100. In other examples, the transparent surface 204 is located on top of a dashboard and in front of the windshield 102 such that the transparent surface 204 is located within the field-of-view 206 of the user 208 during operation of the vehicle 100.

As illustrated in FIG. 2, the projector 202 emits a projection 210 onto a portion 212 of the transparent surface 204 that intersects with the field-of-view 206 of the user 208. The projector 202 emits the projection 210 onto the transparent surface 204 to create a virtual interface 214 for the user 208. The virtual interface 214 of the illustrated example is representative of each of the virtual interface 125 and the virtual interface 127 of FIG. 1.

In the illustrated example, the HUD 200 is configured to emit the projection 210 onto the transparent surface 204 such that an apparent distance 216 at which the virtual interface 214 appears from the perspective of the user 208 does not necessarily match a distance 218 between the transparent surface 204 and the user 208. That is, from the perspective of the user 208 in front of the transparent surface 204, the virtual interface 214 does not necessarily appear to be projected onto the transparent surface 204. For example, the virtual interface 214 appears to be farther away from the user 208 than the transparent surface 204 is to the user 208.

To cause the apparent distance 216 to the virtual interface 214 to be greater than the distance 218 to the transparent surface 204, the HUD 200 of the illustrated example utilizes forced perspective. For example, forced perspective is an optical technique to make an object appear farther away, closer, larger, and/or smaller than the actual size of the object. Forced perspective incorporates the use of scaled objects and their correlation with a vantage point of a spectator to manipulate the perception of those objects by the spectator. In the illustrated example, the projector 202 of the HUD 200 includes an image source 220, a fold mirror 222, a projection screen 224, a main mirror 226, and a transparent cover 228 to incorporate forced perspective within the projection 210 to present the virtual interface 214 at the apparent distance 216. For example, to emit the projection 210, the image source 220 of the projector 202 emits light 230 that (1) reflects off the fold mirror 222, (2) traverses through the projection screen 224, (3) reflects off the main mirror 226, and (4) traverses through the transparent cover 228.

In some examples, the HUD 200 is configured to adjust the projection 210 based upon a location of the user 208 and the apparent distance 216 that is desired. For example, when the apparent distance 216 is a predetermined value (e.g., determined by the HUD controller 128 based upon a mode selected by the passenger 112), the HUD 200 (i) adjusts the projection 210 such that the virtual interface 214 appears closer to the transparent surface 204 in response to the user 208 moving away from the transparent surface 204 and/or (i) adjusts the projection 210 such that the virtual interface 214 appears farther from the transparent surface 204 in response to the user 208 moving closer to the transparent surface 204.

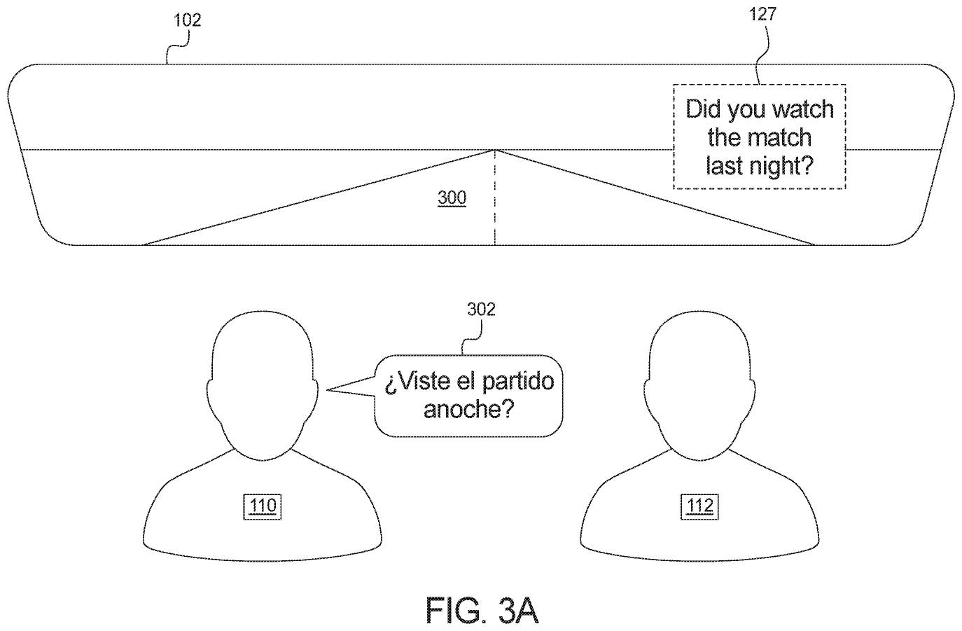

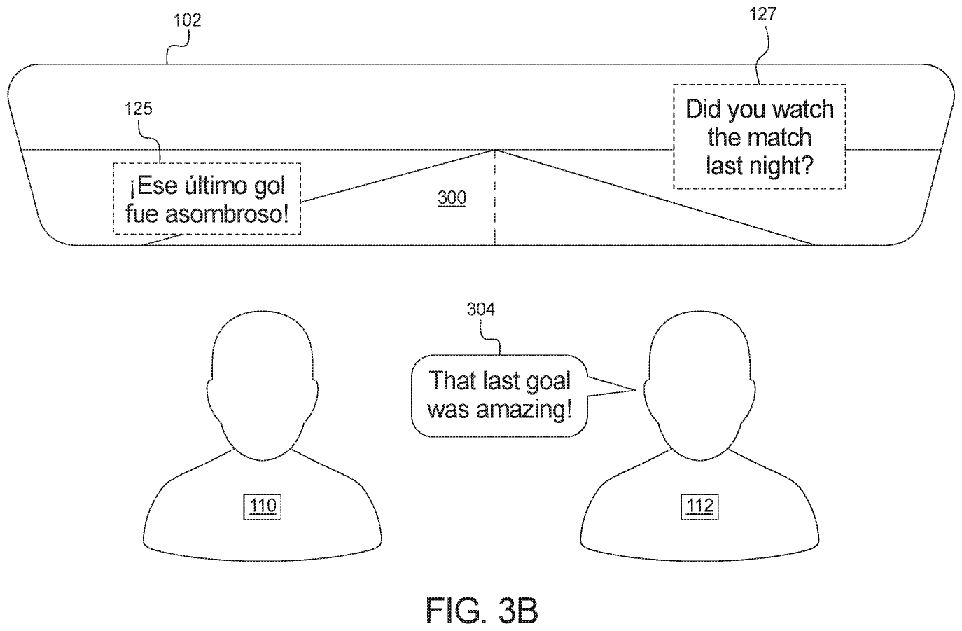

FIG. 3A depicts the passenger HUD 126 when the selected mode of operation is a language mode. When in the language mode, the HUD controller 128 translates speech 302 of the operator 110 to a preferred language of the passenger 112. For example, the microphones 120 capture the speech 302 of the operator 110 to enable the HUD controller 128 to translate the speech into text of another language. In the illustrated example, the HUD controller 128 translates the speech 302 of the operator 110, which is in Spanish, to the preferred language of the passenger 112, which is English. Further, the HUD controller 128 presents the translated speech to the passenger 112 via the passenger HUD 126. As illustrated in FIG. 3A, the virtual interface 127 presented via the passenger HUD 126 is a language interface that includes the translated speech of the operator 110. The language interface is positioned within a field-of-view of the passenger 112 when the passenger 112 is looking through the windshield 102 at an area 300 in front of the vehicle 100. In the illustrated example, an apparent distance (e.g., the apparent distance 216) of the language interface is a reduced distance (i.e., the language interface is closer to the windshield 102) to facilitate the passenger 112 in reading the translated speech of the operator 110.

In some examples, the language interface enables the passenger 112 to identify fare of a ride when the passenger 112 is travelling abroad in a foreign country. For example, the HUD controller 128 converts the fare from the currency of the operator 110 (e.g., the Mexican peso) to the currency of the passenger 112 (e.g., the U.S. dollar) and/or provides tip amounts that are customary within the region and/or city of travel.

FIG. 3B depicts the driver HUD 124 when the selected mode of operation is a language mode. As illustrated in FIG. 3B, the HUD controller 128 is configured to translate speech 304 of the passenger 112 for the operator 110 and/or other passenger(s) of the vehicle 100. For example, the microphones 120 capture the speech 302 of the passenger 112 to enable the HUD controller 128 to translate the speech into text of the preferred language of the operator 110. Additionally, or alternatively, the passenger 112 provides text to the HUD controller 128 for translation into the preferred language of the operator 110. For example, the HUD controller 128 is configured to receive text from a mobile device of the passenger 112 (e.g., a mobile device 522 of FIG. 5) via a communication module of the vehicle 100 (e.g., a communication module 506 of FIG. 5).

In the illustrated example, the HUD controller 128 translates the speech 304 and/or text of the passenger 112, which is in English, to the preferred language of the operator 110, which is Spanish. As illustrated in FIG. 3B, the HUD controller 128 presents the translated speech to the operator 110 of the vehicle 100 via the driver HUD 124 (e.g., when the vehicle 100 is stationary). The virtual interface 125 is positioned within and/or near (e.g., below) a field-of-view of the operator 110 when the operator 110 is looking through the windshield 102 at the area 300 in front of the vehicle 100. In other examples, the HUD controller 128 visually presents the translated speech to the operator 110 and/or other passenger(s) of the vehicle 100 via another display (e.g., the center console display 116). Additionally, or alternatively, the HUD controller 128 audibly presents the translated speech of the passenger 112 to the operator 110 via the speakers 118 of the vehicle 100 (e.g., when the vehicle 100 is in motion).

Further, in some examples, the HUD controller 128 determines that the operator 110 is attempting to speak to the passenger 112 if there is only one passenger within the cabin 104 and the windows are closed. Additionally, or alternatively, the HUD controller 128 identifies a need to translate speech based on detected speech of the occupants and/or preferred language(s) of connected devices. Further, in some examples, the HUD controller 128 does not automatically translate the speech of the operator 110 to the passenger 112 upon determining that the operator 110 is engaged in a phone call or has opened the window or door. In some such examples, the HUD controller 128 provides a pop-up selection to the operator 110 that enables the operator 110 to select “translate speech for passenger.” Further, in some examples, the HUD controller 128 provides a pop-up selection to the operator 110 if there are multiple passengers speaking different languages within the cabin 104 of the vehicle 100.

Additionally, or alternatively, the passenger HUD 126 is configured to present information from and/or an interface of a mobile device (e.g., the mobile device 522) of the passenger 112 when the selected mode of operation is a mobile device mode. For example, when the selected mode is the mobile device mode, the virtual interface 127 includes information and/or an interface of the mobile device that the HUD controller 128 receives via a communication module (e.g., the communication module 506) of the vehicle 100. The mobile device mode enables the passenger HUD 126 to operate as a supplement of and/or back-up to a display of the mobile device. In the mobile device mode, the apparent distance of the virtual interface 127 is a reduced distance (i.e., closer to the windshield 102) to facilitate the passenger 112 in viewing the information and/or interface of the mobile device.

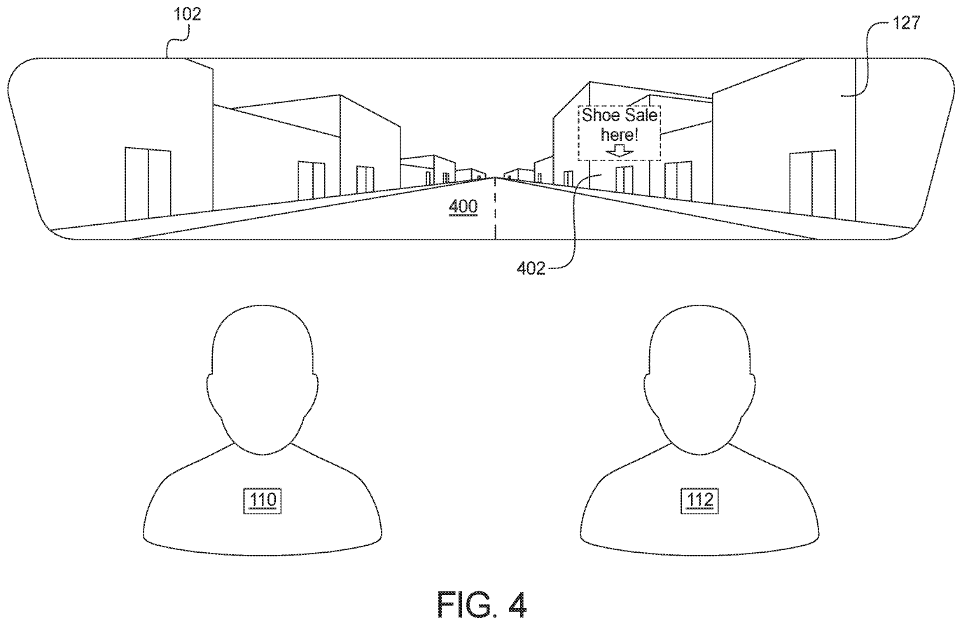

FIG. 4 depicts the passenger HUD 126 when the selected mode of operation is a point-of-interest (POI) mode. When in the POI mode, the HUD controller 128 identifies and/or presents information regarding one or more nearby POIs to the passenger 112. For example, the passenger HUD 126 (1) identifies a current location of the vehicle 100 (e.g., via a telematics control unit 536 of FIGS. 5) and (2) retrieves information corresponding to nearby POI(s) based on the vehicle location. For example, the passenger HUD 126 retrieves information of POI(s) from a remote server (e.g., a remote server 524 of FIG. 5) via a communication module of the vehicle 100 (e.g., a communication module 508 of FIG. 5). Further, in some examples, the passenger HUD 126 determines which POI(s) to identify and present for the passenger 112 based upon a user profile of the passenger 112. For example, the passenger HUD 126 selects POI(s) that correspond to identified interests of the passenger 112.

As illustrated in FIG. 4, the HUD controller 128 identifies and/or presents details corresponding with nearby POI(s) to the passenger 112 via the passenger HUD 126. The virtual interface 127 presented via the passenger HUD 126 is a POI interface that identifies one or more POIs to the passenger 112. For example, the POI interface presents information corresponding to one or more POIs that are within an area 400 in front of the vehicle 100. In the illustrated example, an apparent distance (e.g., the apparent distance 216) of the POI interface is an increased distance (i.e., the language interface is farther to the windshield 102) such that the POI interface overlays onto the POI as viewed by the passenger 112 through the windshield 102.

For example, the vehicle 100 includes a camera (e.g., a front camera 528 of FIG. 5) that captures image(s) and/or video of the area 400 in front of the vehicle 100. The HUD controller 128 utilizes image recognition software, for example, to identify the nearby POI(s) and/or to determine a location of the POI(s) relative to the vehicle 100. Further, the HUD controller 128 creates the POI interface to identify the POI(s) within the captured image(s) and/or video such that the POI interface presented via the passenger HUD 126 overlays the POI(s) as viewed by the passenger 112 through the windshield 102. For example, the HUD controller 128 adjusts the apparent distance of the POI interface to enable the POI interface to be positioned near one or more POIs from the perspective of the passenger 112.

In the illustrated example, the HUD controller 128 is configured to enable the passenger 112 to instruct the operator 110 to take a detour to a POI. For example, the HUD controller 128 enables the passenger 112 to select a POI for which information is presented via the POI interface. In some examples, the passenger 112 makes a hand gesture to select the POI. For example, the HUD controller 128 detects the hand gesture that corresponds with the POI based upon image(s) and/or video captured by one or more of the cameras 122. Upon identifying the selection made by the passenger 112, the HUD controller 128 prompts the passenger 112 (e.g., via the POI display) to select whether the passenger 112 would like to take a detour to the POI. In response to the passenger 112 selecting that they would like a detour, the HUD controller 128 instructs the operator 110 to (e.g., via the driver HUD 124) and/or causes the vehicle to autonomously take a detour to the selected POI. For example, the HUD controller 128 instructs the operator 110 to the selected POI (e.g., via the driver HUD 124).

In some examples, the POI(s) include landmark(s), restaurant(s), and/or other points-of-interest to a tourist. Further, when the passenger 112 is being driven to a POI, the virtual interface 127 is configured to include an arrival time, a travel time, and/or a selected route to the point-of-interest. Additionally, or alternatively, the POI(s) include restaurant(s), shop(s), and/or other store(s) that are potentially of interest to the passenger 112. For example, the virtual interface 127 is configured to include information, such as sales, to the passenger 112 to enable the passenger 112 to determine whether they would like to take a detour to the identified store.

Additionally, or alternatively, the passenger HUD 126 is configured to present image(s) and/or video to the operator 110 and/or the passenger 112 of the surrounding area as the operator 110 and/or the passenger 112 exits the cabin 104 for safety purposes. For example, the driver HUD 124 presents a captured image and/or video of the surrounding area in response to the HUD controller 128 detecting that the operator 110 is exiting the cabin 104 from the driver's seat 106. Additionally, or alternatively, the passenger HUD 126 presents a captured image and/or video of the surrounding area in response to the HUD controller 128 detecting that the passenger 112 is exiting the cabin 104 from the passenger seat 108.

FIG. 5 is a block diagram of electronic components 500 of the vehicle 100. As illustrated in FIG. 5, the electronic components 500 include an on-board computing platform 502, displays 504, the speakers 118, a communication module 506, a communication module 508, cameras 510, sensors 512, the microphones 120, electronic control units (ECUs) 514, and a vehicle data bus 516.

The on-board computing platform 502 includes a processor 518 (also referred to as a microcontroller unit and a controller) and memory 520. In the illustrated example, the processor 518 of the on-board computing platform 502 is structured to include the HUD controller 128. In other examples, the HUD controller 128 is incorporated into another ECU with its own processor and memory. The processor 518 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 520 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 520 includes multiple kinds of memory, particularly volatile memory and non-volatile memory.

The memory 520 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 520, the computer readable medium, and/or within the processor 518 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The displays 504 are configured to present interfaces and/or other visual information to occupants (e.g., the operator 110, the passenger 112) of the vehicle 100. In some examples, the displays 504 include a heads-up display, a liquid crystal display (LCD), an organic light emitting diode (OLED) display, a flat panel display, a solid state display, and/or any other type of display that is configured to present interfaces and/or other visual information to occupants of the vehicle 100. In the illustrated example, the displays 504 include the center console display 116, the driver HUD 124, and the passenger HUD 126.

The communication module 506 of the illustrated example includes wired or wireless network interface(s) to enable wireless communication with a mobile device 522 (e.g., a smart phone, a wearable, a smart watch, a tablet, etc.) of the passenger 112. The communication module 506 also includes hardware (e.g., processors, memory, storage, antenna, etc.) and software to control the wireless network interface(s). For example, the communication module 506 includes communication controller(s) for Wi-Fi® communication, Bluetooth® communication, Bluetooth® Low Energy (BLE) communication, and/or other personal or local area wireless network protocols (e.g., Zigbee®, Z-Wave®, etc.). Further, in some examples, the communication module 506 includes one or more communication controllers for cellular network(s) (e.g., Global System for Mobile Communications (GSM), Universal Mobile Telecommunications System (UMTS), Long Term Evolution (LTE), Code Division Multiple Access (CDMA)), Near Field Communication (NFC), and/or other standard-based network(s). In the illustrated example, the communication module 506 is communicatively coupled to the mobile device 522 of the passenger 112. For example, the communication module 506 enables the HUD controller 128 to receive mode selection(s) and/or other input(s) from the passenger 112 via the mobile device 522. Additionally, or alternatively, the communication module 506 enables the HUD controller 128 to receive an interface and/or other information from the mobile device 522 that is subsequently displayed via the passenger HUD 126.

The communication module 508 of the illustrated example includes wired or wireless network interface(s) to enable communication with a remote server 524 via an external network 526. The external network 526 may be a public network, such as the Internet; a private network, such as an intranet; or combinations thereof, and may utilize a variety of networking protocols now available or later developed including, but not limited to, TCP/IP-based networking protocols. The communication module 508 also includes hardware (e.g., processors, memory, storage, antenna, etc.) and software to control the wired or wireless network interface(s). In the illustrated example, the communication module 508 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module 508 includes a wired or wireless interface (e.g., an auxiliary port, a Universal Serial Bus (USB) port, a Bluetooth® wireless node, etc.) to communicatively couple with the mobile device 522 of the passenger 112. In such examples, the vehicle 100 may communicate with the external network 526 via the mobile device 522. In the illustrated example, the communication module 508 retrieves information from the remote server 524 via the external network 526. For example, the communication module 508 receive(s) speech translations of the operator 110, speech translations of passenger 112, information related to a nearby point-of-interest, directions to the nearby point-of-interest, entertainment media, etc.

The cameras 510 collect image(s) and/or video of area(s) within and/or surrounding the vehicle 100. In the illustrated example, the cameras 510 include the cameras 122, a front camera 528, and a rear camera 530. The cameras 122 captures image(s) and/or video of the passenger 112 while seated in the passenger seat 108. For example, the cameras 122 monitors the passenger 112 to enable the HUD controller 128 to detect a position of the passenger 112 relative to the passenger seat 108 and/or the windshield 102. Additionally, or alternatively, the cameras 122 monitors the passenger 112 to enable the HUD controller 128 to detect a hand and/or other input gesture provided by the passenger 112 that corresponds to an interface being displayed by the passenger HUD 126. Further, the front camera 528 captures image(s) and/or video of an area in front of the vehicle 100, and the rear camera 530 captures image(s) and/or video of an area behind the vehicle 100. For example, the passenger HUD 126 presents the image(s) and/or video of the surrounding area that are captured by the front camera 528 and/or the rear camera 530 in response to the HUD controller 128 detecting that the passenger 112 is exiting the vehicle 100.

The sensors 512 are arranged in and/or around the vehicle 100 to monitor properties of the vehicle 100 and/or an environment in which the vehicle 100 is located. One or more of the sensors 512 may be mounted to measure properties around an exterior of the vehicle 100. Additionally, or alternatively, one or more of the sensors 512 may be mounted inside a cabin of the vehicle 100 or in a body of the vehicle 100 (e.g., an engine compartment, wheel wells, etc.) to measure properties in an interior of the vehicle 100. For example, the sensors 512 include accelerometers, odometers, tachometers, pitch and yaw sensors, wheel speed sensors, microphones, tire pressure sensors, biometric sensors and/or sensors of any other suitable type.

In the illustrated example, the sensors 512 include an occupancy sensor 532 and a transmission sensor 534. For example, the occupancy sensor 532 is configured to detect whether the passenger seat 108 is occupied or unoccupied by the passenger 112. The occupancy sensor 532 includes a weight sensor, a pressure sensor, a seatbelt sensor, an infrared sensor, a proximity sensor (e.g., a radar sensor, a LIDAR sensor, an ultrasonic sensor), a motion detection sensor, and/or any other sensor configured to detect (a change in) occupancy of the passenger seat 108. The transmission sensor 534 is configured to detect a position of a transmission (e.g., drive, reverse, park, neutral) of the vehicle 100. In some examples, the HUD controller 128 detects that the passenger 112 is exiting the cabin 104 of the vehicle 100 in response to (1) the occupancy sensor 532 detecting that passenger 112 is getting up from the passenger seat 108 and/or (2) the transmission sensor 534 detects that the transmission has shifted into park.

The ECUs 514 monitor and control the subsystems of the vehicle 100. For example, the ECUs 514 are discrete sets of electronics that include their own circuit(s) (e.g., integrated circuits, microprocessors, memory, storage, etc.) and firmware, sensors, actuators, and/or mounting hardware. The ECUs 514 communicate and exchange information via a vehicle data bus (e.g., the vehicle data bus 516). Additionally, the ECUs 514 may communicate properties (e.g., status of the ECUs 514, sensor readings, control state, error and diagnostic codes, etc.) to and/or receive requests from each other. For example, the vehicle 100 may have dozens of the ECUs 514 that are positioned in various locations around the vehicle 100 and are communicatively coupled by the vehicle data bus 516. In the illustrated example, the ECUs 514 include a telematics control unit 536 that controls tracking of the vehicle 100. For example, the telematics control unit 536 utilizes data collected from a global positioning server (GPS) receiver of the vehicle 100 to determine a location of the vehicle 100. In some examples, the HUD controller 128 collects information to be displayed via the passenger HUD 126 based on tracking of the vehicle location by telematics control unit 536.

The vehicle data bus 516 communicatively couples the speakers 118, the microphones 120, the on-board computing platform 502, the displays 506, the communication module 506, the communication module 508, the cameras 510, the sensors 512, and the ECUs 514. In some examples, the vehicle data bus 516 includes one or more data buses. The vehicle data bus 516 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

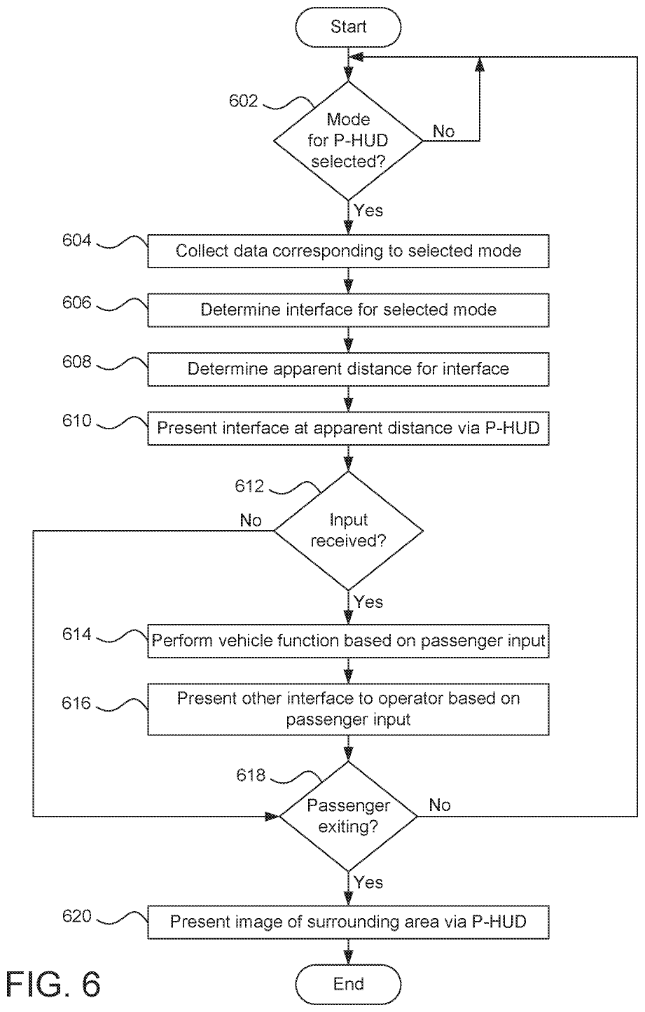

FIG. 6 is a flowchart of an example method for presenting an interface via a passenger heads-up display. The flowchart of FIG. 6 is representative of machine readable instructions that are stored in memory (such as the memory 520 of FIG. 5) and include one or more programs which, when executed by a processor (such as the processor 518 of FIG. 5), cause the vehicle 100 to implement the example HUD controller 128 of FIGS. 1 and 5. While the example program is described with reference to the flowchart illustrated in FIG. 6, many other methods of implementing the example HUD controller 128 may alternatively be used. For example, the order of execution of the blocks may be rearranged, changed, eliminated, and/or combined to perform the method 600. Further, because the method 600 is disclosed in connection with the components of FIGS. 1-5, some functions of those components will not be described in detail below.

Initially, at block 602, the HUD controller 128 determines whether a mode for the passenger HUD 126 is selected. In response to the HUD controller 128 determining that a mode has not been selected, the method 600 remains at block 602. Otherwise, in response to the HUD controller 128 determining that a mode has been selected, the method 600 proceeds to block 604. At block 604, the HUD controller 128 collects information corresponding to the selected mode. For example, the HUD controller 128 collects information regarding the preferred languages of the operator 110 and/or the passenger 112 if the selected mode is the language mode, collects information regarding nearby POI(s) and/or a user profile of the passenger 112 if the selected module is the POI mode, etc. At block 608, the HUD controller 128 determines the virtual interface 127 to be presented for the selected mode. At block 610, the HUD controller 128 determines the apparent distance 216 at which the virtual interface 127 is to be presented for the passenger 112. At block 610, the HUD controller 128 presents the virtual interface 127 at the apparent distance 216 via the passenger HUD 126.

At block 612, the HUD controller 128 determines whether an input has been received from or for the passenger 112 regarding the information presented to the passenger 112 via the passenger HUD 126. In response to the HUD controller 128 determining that an input has not been received, the method 600 proceeds to block 618. Otherwise, in response to the HUD controller 128 determining that an input has been received, the method 600 proceeds to block 614 at which the HUD controller 128 causes a vehicle function to be performed based on the received input. At block 616, the HUD controller 128 presents another interface to the operator 110 (e.g., the virtual interface 125) based on the on the input received from the operator 110. For example, the HUD controller 128 presents directions to a POI to which the passenger 112 has selected to take a detour.

At block 618, the HUD controller 128 determines whether the passenger 112 is exiting the cabin 104 of the vehicle 100. In response to the HUD controller 128 determining that the passenger 112 is not exiting the cabin 104, the method 600 returns to block 602. Otherwise, in response to the HUD controller 128 determining that the passenger 112 is exiting the cabin 104, the method 600 proceeds to block 620 at which the passenger HUD 126 presents image(s) and/or video of a surrounding area of the vehicle 100 to facilitate the passenger 112 in safely exiting the cabin 104 of the vehicle 100.

An example disclosed vehicle includes a passenger seat, a passenger heads-up display (HUD) to present a virtual interface in front of the passenger seat, and a controller. The controller is to identify a mode selection for the passenger HUD and determine, based on the mode selection, the virtual interface and an apparent distance of the virtual interface for a passenger. The controller also is to present, via the passenger HUD, the virtual interface at the apparent distance for the passenger.

In some examples, the apparent distance is a distance at which the virtual interface appears from a perspective of the passenger. Some examples further include a windshield. In such examples, the passenger HUD includes a projector that is configured to emit a projection onto the windshield to create the virtual interface. In such examples, the controller utilizes forced perspective to cause the virtual interface to appear farther than the windshield for the passenger.

In some examples, the virtual interface presented by the passenger HUD is not viewable from a driver's seat. Some examples further include a driver's seat for an operator and a driver HUD to present a virtual operator interface in front of the driver's seat to the operator. Some examples further include a camera configured to capture images of the passenger to enable the controller to detect a gesture of the passenger.

In some examples, the selected mode includes a point-of-interest (POI) mode, the virtual interface includes a POI interface that identifies a POI to the passenger, and the apparent distance of the POI interface is an increased distance.

Some such examples further include a camera to capture an image of an environment in front of the vehicle. Further, in some such examples, the controller creates the POI interface to identify the POI within the image and the passenger HUD presents the POI interface to overlay onto the POI as viewed by the passenger through a windshield. Further, in some such examples, the passenger HUD presents the image to the passenger in response to the controller detecting that the passenger is exiting a vehicle cabin from the passenger seat.

Some such examples, further include a telematics control unit to identify a vehicle location and a communication module to retrieve information for the POI based upon the vehicle location. Further, in some such examples, the controller determines the POI based upon a user profile of the passenger. Moreover, in some such examples, the controller is to enable the passenger to select a detour to the POI upon the passenger HUD presenting the information for the POI in the POI interface and provide directions to the POI for a driver.

In some examples, the selected mode includes a language mode, the virtual interface includes a language interface that translates speech of a driver for the passenger, and the apparent distance of the POI interface is a reduced distance. Some such examples further include a microphone to capture the speech of the driver. In such examples, the controller translates the speech of the driver to a preferred language of the passenger and presents the translated speech to the passenger via the passenger HUD. Further, in some such examples, the microphone captures the speech of the passenger and the controller translates the speech of the passenger for the driver. Moreover, some such examples further include a second display to visually present the translated speech of the passenger to the driver. Moreover, some such examples further include a speaker to audibly present the translated speech of the passenger to the driver. Further, some such examples further include a communication module to receive a mobile interface from a mobile device of the passenger. In such examples, the selected mode is a mobile device mode for which the passenger HUD presents the mobile interface and the apparent distance of the mobile interface is a second reduced distance.

An example disclosed method includes identifying a mode selection from a passenger of a vehicle for a passenger heads-up display (HUD). The passenger HUD is configured to present a virtual interface in front of a passenger seat. The example disclosed method also includes determining, via a processor, the virtual interface and an apparent distance of the virtual interface for the passenger based on the mode selection. The example disclosed method also includes presenting, via the passenger HUD, the virtual interface at the apparent distance for the passenger.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module” and “unit” refer to hardware with circuitry to provide communication, control and/or monitoring capabilities. A “module” and a “unit” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a passenger seat;
a passenger heads-up display (HUD) to present a virtual interface in front of the passenger seat; and
a controller to:
identify a mode selection for the passenger HUD;
determine, based on the mode selection, the virtual interface and an apparent distance of the virtual interface for a passenger; and
present, via the passenger HUD, the virtual interface at the apparent distance for the passenger.

2. The vehicle of claim 1, wherein the apparent distance is a distance at which the virtual interface appears from a perspective of the passenger.

3. The vehicle of claim 1, further including a windshield, wherein the passenger HUD includes a projector that is configured to emit a projection onto the windshield to create the virtual interface, wherein the controller utilizes forced perspective to cause the virtual interface to appear farther than the windshield for the passenger.

4. The vehicle of claim 1, wherein the virtual interface presented by the passenger HUD is not viewable from a driver's seat.

5. The vehicle of claim 1, further including a driver's seat for an operator and a driver HUD to present a virtual operator interface in front of the driver's seat to the operator.

6. The vehicle of claim 1, further including a camera configured to capture images of the passenger to enable the controller to detect a gesture of the passenger.

7. The vehicle of claim 1, wherein the selected mode includes a point-of-interest (POI) mode, the virtual interface includes a POI interface that identifies a POI to the passenger, and the apparent distance of the POI interface is an increased distance.

8. The vehicle of claim 7, further including a camera to capture an image of an environment in front of the vehicle.

9. The vehicle of claim 8, wherein the controller creates the POI interface to identify the POI within the image, wherein the passenger HUD presents the POI interface to overlay onto the POI as viewed by the passenger through a windshield.

10. The vehicle of claim 8, wherein the passenger HUD presents the image to the passenger in response to the controller detecting that the passenger is exiting a vehicle cabin from the passenger seat.

11. The vehicle of claim 7, further including:
a telematics control unit to identify a vehicle location; and
a communication module to retrieve information for the POI based upon the vehicle location.

12. The vehicle of claim 11, wherein the controller determines the POI based upon a user profile of the passenger.

13. The vehicle of claim 12, wherein the controller is to:
enable the passenger to select a detour to the POI upon the passenger HUD presenting the information for the POI in the POI interface; and
provide directions to the POI for a driver.

14. The vehicle of claim 7, wherein the selected mode includes a language mode, the virtual interface includes a language interface that translates speech of a driver for the passenger, and the apparent distance of the POI interface is a reduced distance.

15. The vehicle of claim 14, further including a microphone to capture the speech of the driver, wherein the controller translates the speech of the driver to a preferred language of the passenger and presents the translated speech to the passenger via the passenger HUD.

16. The vehicle of claim 15, wherein the microphone captures the speech of the passenger and the controller translates the speech of the passenger for the driver.

17. The vehicle of claim 16, further including a second display to visually present the translated speech of the passenger to the driver.

18. The vehicle of claim 16, further including a speaker to audibly present the translated speech of the passenger to the driver.

19. The vehicle of claim 15, further including a communication module to receive a mobile interface from a mobile device of the passenger, wherein the selected mode is a mobile device mode for which the passenger HUD presents the mobile interface, wherein the apparent distance of the mobile interface is a second reduced distance.

20. A method comprising:
identifying a mode selection from a passenger of a vehicle for a passenger heads-up display (HUD), the passenger HUD is configured to present a virtual interface in front of a passenger seat;
determining, via a processor, the virtual interface and an apparent distance of the virtual interface for the passenger based on the mode selection; and
presenting, via the passenger HUD, the virtual interface at the apparent distance for the passenger.
